(19) United States
(12) Patent Application Publication
(10) Pub. No.: US 2006/0122924 A1
(43) Pub. Date: Jun. 8, 2006

(54) Retirement income calculator

(75) Inventors: Scott A. Brustkern, Ankeny, IA (US); Drew A. Denning, Ankeny, IA (US); Chris L. Mayer, Waukee, IA (US)

Correspondence Address: MCKEE, VOORHEES & SEASE, P.L.C., 801 GRAND AVENUE, SUITE 3200, DES MOINES, IA, 50309-2721, US

(73) Assignee: Principal Financial Services, Inc., Des Moines, IA (US)

(21) Appl. No.: 11/293,951

(22) Filed: Dec. 5, 2005

Related U.S. Application Data
(60) Provisional application No. 60/633,597, filed on Dec. 6, 2004.

(51) Int. Cl. G06Q 40/00

(52) U.S. Cl. 705/35

(57) ABSTRACT

A retirement savings calculator for computing a deferral percentage needed to replace income at retirement age. One embodiment includes a sleeve having an open end and a plurality of windows. An insert is slidably inserted into the open end of the sleeve. The retirement savings calculator calculates a savings ratio based on savings and income. A deferral percentage is calculated based on the savings ratio, current age, and replacement income percentage. In another embodiment, the deferral percentage is calculated in software. The retirement savings calculator can be used to promote savings in a retirement plan.

### CROSS-REFERENCE TO RELATED APPLICATIONS

This application claims priority to U.S. Provisional Patent Application Ser. No. 60/633,597 filed Dec. 6, 2004, which is incorporated by reference herein in its entirety.

### BACKGROUND OF THE INVENTION

There is a general concern that individuals are not saving sufficiently for retirement. Although the problem is generally well recognized, it is sometimes difficult for individuals to personalize the problem and take the appropriate steps to increase their retirement savings.

One of the difficulties of retirement savings is that typically an individual would need to perform a number of complex calculations in order to determine how best to reach their retirement savings goals. Typically, an individual requires appropriate guidance from a financial counselor who provides a number of time consuming calculations that require a great number of inputs.

This provides difficulties in promoting retirement savings plans and the need for retirement savings. In particular, in order to properly promote a retirement savings plan or to encourage appropriate use of a retirement savings plan requires individuals to internalize their own need for increased retirement savings and to quantify that need so that they can take the necessary steps to increase their retirement savings.

Thus, there is a need for an easy-to-use tool that allows individuals to easily and quickly determine if they are on track to meet their requirement or if they are not, what they can do in terms of changing their deferral rate in order to get on track to meeting their retirement savings goals.

Thus, it is an object, feature or advantage of the present invention to improve upon the state of the art.

A further object, feature or advantage of the present invention is to encourage individuals to accumulate retirement savings.

Another object, feature or advantage of the present invention is to encourage individuals to save at an appropriate level to meet their retirement goals.

Another object, feature or advantage of the present invention is to provide a mechanism for encouraging individuals to save for retirement by making an appropriate level of deferral of their income to a retirement plan.

A still further object, feature or advantage of the present invention is to provide a simple mechanism for individuals to quickly determine their need for taking action with respect to their current salary deferral percentage and what is needed in order to properly save for retirement.

Yet another object, feature, or advantage of the present invention is to provide a tool that is inexpensive to produce and distribute.

One or more of these and/or other objects, features or advantages of the present invention will become apparent from the specification and claims that follow.

### SUMMARY OF THE INVENTION

The invention includes a slide ruler type apparatus for calculating a deferral percentage needed for adequate retirement savings. Essentially, the device includes a sleeve. An insert can be slid up and down within the sleeve. The insert that is slid up and down has tables of information on both sides. There is a window on each side of the sleeve. The user slides the insert up and down until the user's current savings is shown in the window. The user then reads across the window to find a savings ratio that corresponds with their salary. Next, the user flips the apparatus over. There is a second window for inputting the savings ratio on the other side. The user slides the insert up and down until the appropriate savings ratio is shown in the second window. Then the user reads across the window to determine the appropriate deferral rate for their age and desired income replacement ratio.

Only two inputs are needed for the slide ruler—current salary and current savings to generate a required savings rate for different ages and income replacement ratios. Setting the retirement goals as a percentage of projected salary at retirement age, in conjunction with the process of mathematically converting current retirement savings to a percentage of current salary allows the second side of the apparatus to provide results that do not depend on current salary. In other words, without this conversion, the matrix of results by age and income replacement would also require salary as a third variable resulting in an unmanageable set of outputs to be performed on a slide rule type device.

According to one aspect of the present invention, a retirement savings calculator for computing a deferral percentage needed to replace income at retirement age is provided. The retirement savings calculator includes a sleeve having an open end and a plurality of windows. An insert is slidably insertable into the open end of the sleeve. The insert has a plurality of savings values and a plurality of savings ratios printed upon the insert. The plurality of savings values and the plurality of savings ratios are arranged upon the insert such that when the insert is positioned in the open end of the sleeve, one of the savings values of the insert and a corresponding savings ratio of the insert is exposed through at least one of the plurality of windows. The corresponding savings ratio also corresponds with a salary value printed on the sleeve. Thus, a user can determine a savings ratio using the retirement savings calculator based upon their savings, and their salary.

According to another aspect of the present invention, a retirement savings calculator is provided. The retirement savings calculator includes a means for revealing a savings ratio based on a savings value and a salary value. The retirement savings calculator includes a means for revealing a deferral percentage needed to replace income at retirement based on the savings ratio, a current approximate age, and a replacement income percentage.

According to another aspect of the present invention, a retirement savings calculator for computing a deferral percentage needed to replace income at retirement age includes a sleeve and insert slidably positionable within the sleeve. There is a savings ratio window for revealing a savings ratio based on salary and savings. There is a deferral percentage window for revealing the deferral percentage needed to replace income at retirement age.

According to another aspect of the present invention, a method of promoting contributions to a retirement plan is provided. The method includes providing a retirement savings calculator to retirement plan participants. Preferably the retirement savings calculator is adapted for computing a deferral percentage needed to replace income at retirement age. Also, preferably the retirement savings calculator includes a sleeve and an insert.

According to another aspect of the present invention, a retirement savings calculator includes a savings input for a savings value, a salary input for salary value, and a deferral percentage output for a deferral percentage needed to reach a retirement savings goal. The retirement savings calculator can be implemented in software or in a physical embodiment.

### BRIEF DESCRIPTION OF THE DRAWINGS

FIG. 1 is a front view of one embodiment of the present invention.

FIG. 2 is a rear view of one embodiment of the present invention.

FIG. 3 is a front view of one embodiment of an insert of the present invention.

FIG. 4 is a rear view of one embodiment of an insert of the present invention.

FIG. 5 is a front view of one embodiment of a sleeve of the present invention.

FIG. 6 is a rear view of one embodiment of a sleeve of the present invention.

FIG. 7 is a perspective view of one embodiment of a sleeve of the present invention.

FIG. 8 illustrates one embodiment of a screen display illustrating another embodiment of the present invention.

FIG. 9 is a front view of another embodiment of the present invention.

FIG. 10 is a rear view of another embodiment of the present invention.

FIG. 11 is a front view of another embodiment of an insert of the present invention.

FIG. 12 is a rear view of another embodiment of the present invention.

### DETAILED DESCRIPTION OF THE PREFERRED EMBODIMENT

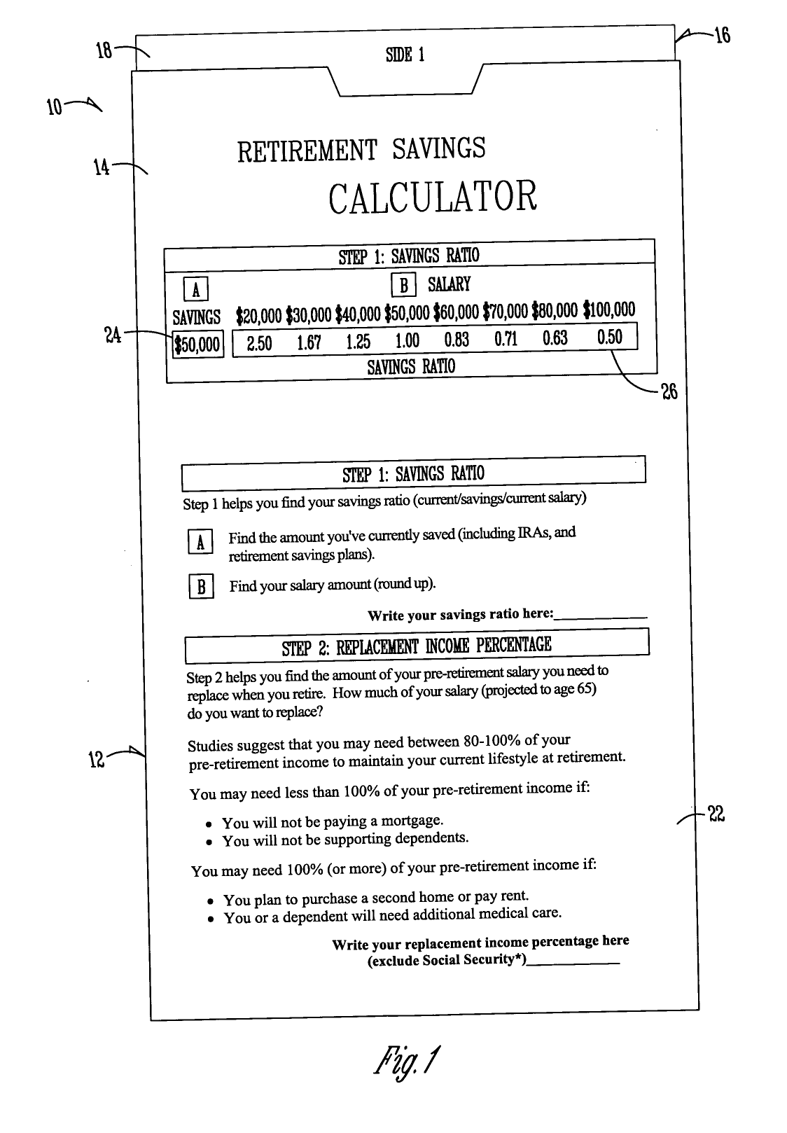

FIG. 1 illustrates one embodiment of the retirement savings calculator 10 of the present invention. The retirement savings calculator 10 includes a sleeve 12 and an insert 16. The insert 16 is inserted into the sleeve 12. As shown in FIG. 1, the sleeve has a front side 14 and a rear side (not shown). Similarly, the insert has a front side 18 and a rear side (not shown). The sleeve has a top end 20 and a bottom end 22. Preferably, the top end 20 is open so that the insert 16 can be slid up and down within the sleeve 12. The sleeve 12 has one or more windows or apertures 24, 26.

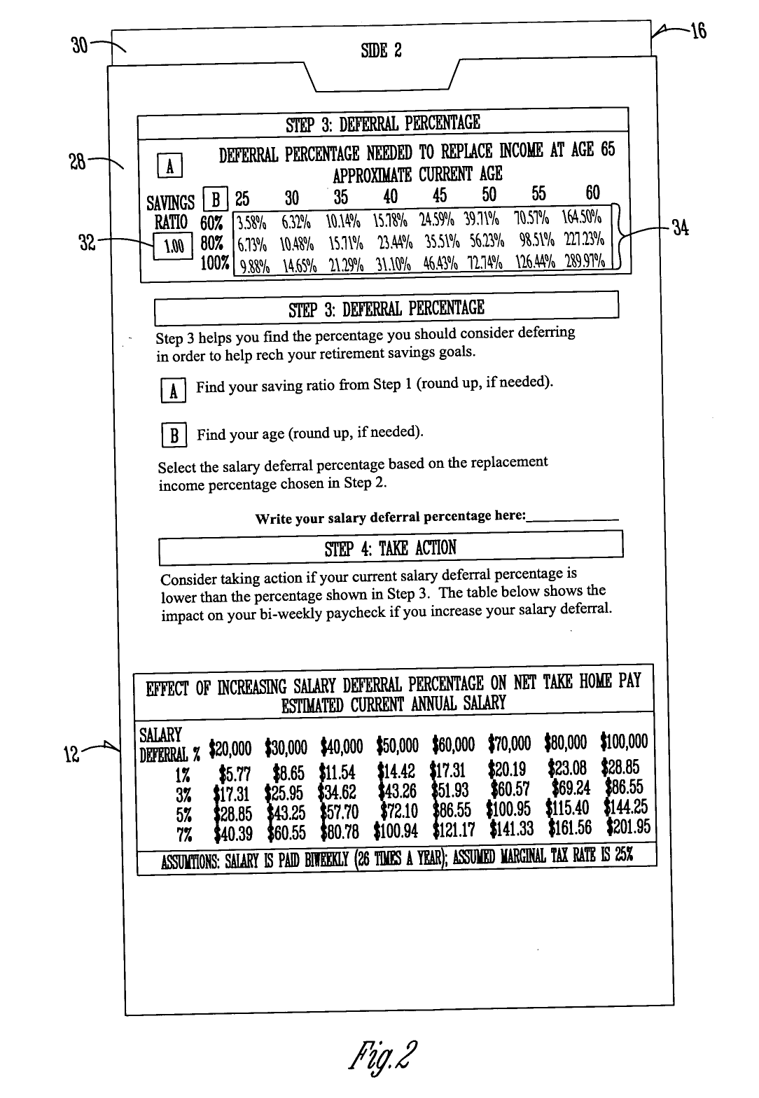

FIG. 2 illustrates a rear view of the retirement savings calculator 10. In FIG. 2, the rear side 28 of the retirement savings calculator 10 is shown. A portion of the insert 16 is shown with the second side of 30 of the insert 16 shown. The insert shown has windows or apertures 32 and 34.

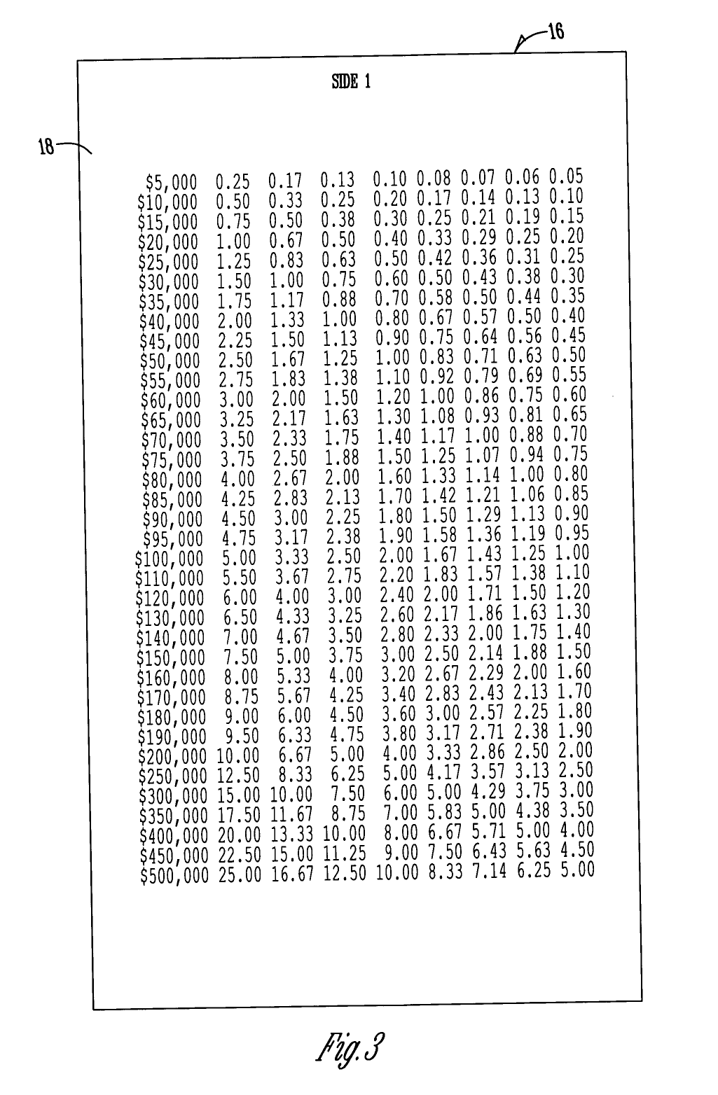

FIG. 3 illustrates a first side or front side 18 of the insert 16. As shown, a first column provides a retirement savings amount and subsequent columns provide a percentage of salary that various income levels represent.

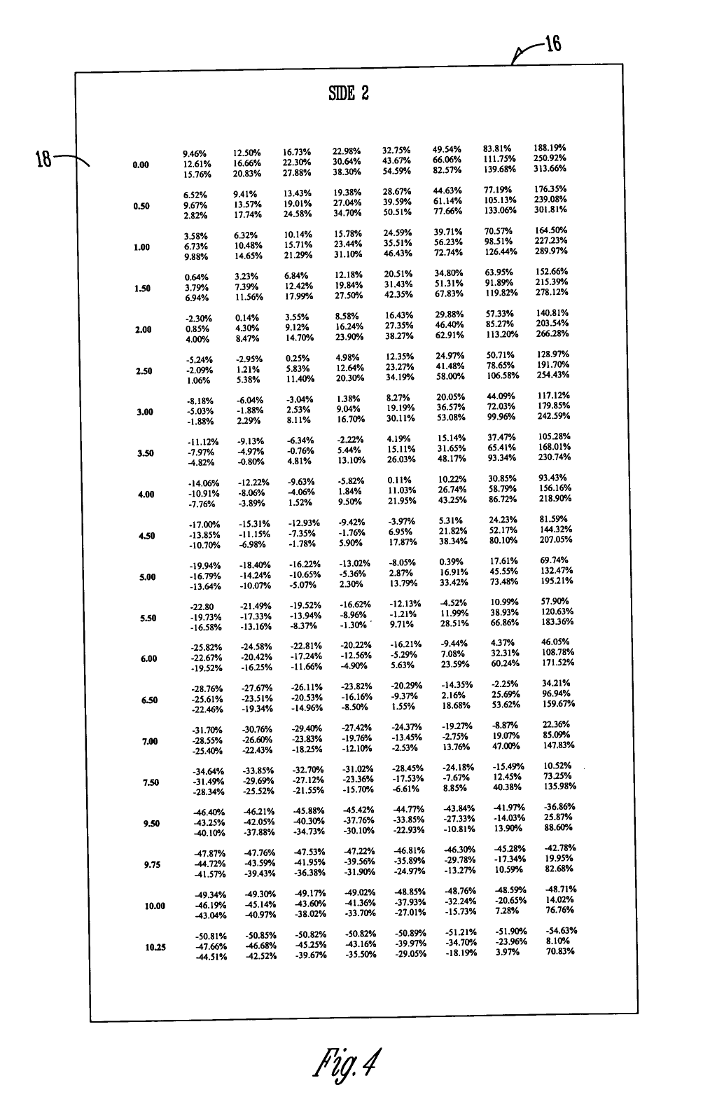

FIG. 4 illustrates the second side or rear side 28 of the insert 16. The tables provides the full annual deferral percentages needed to replace income at age 65 for the various savings ratios shown in the left column. Each column to the right represents annual deferral rates for different current ages.

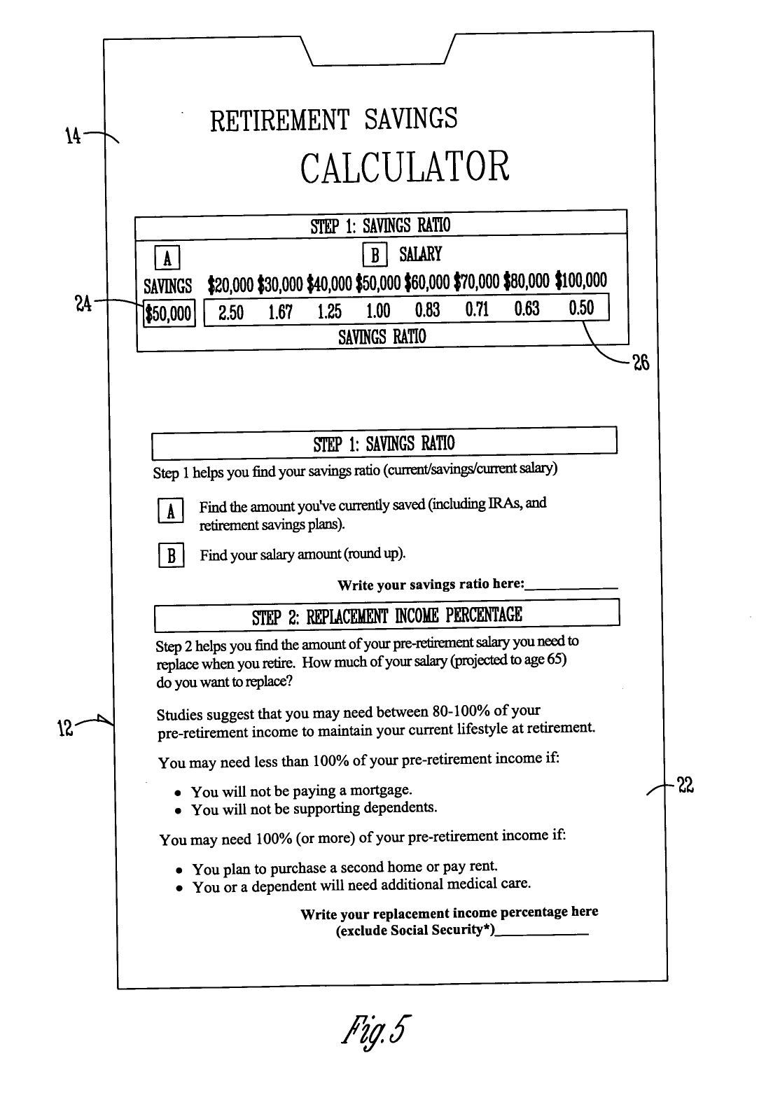

FIG. 5 illustrates one embodiment of the front view of the retirement savings calculator 10. The front side 14 is shown with windows 24 and 26.

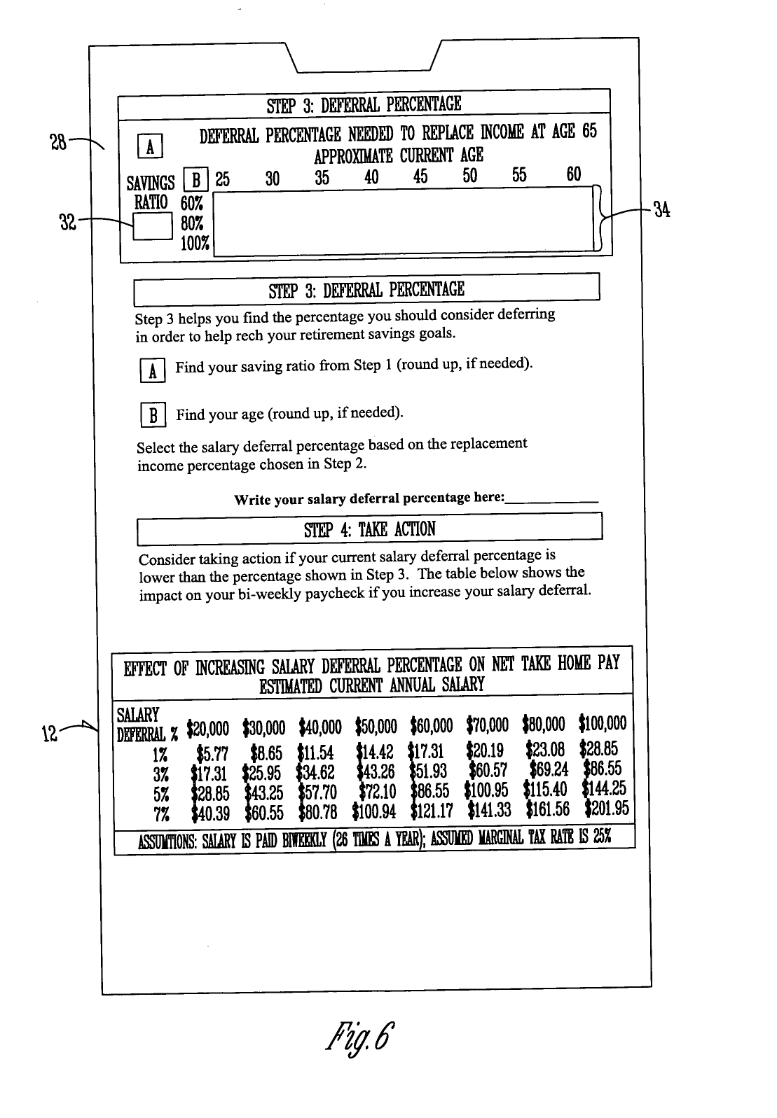

FIG. 6 illustrates a second side or rear side of the pocket 12. In FIG. 6 the second side or rear side 28 is shown having windows or apertures 32 and 34.

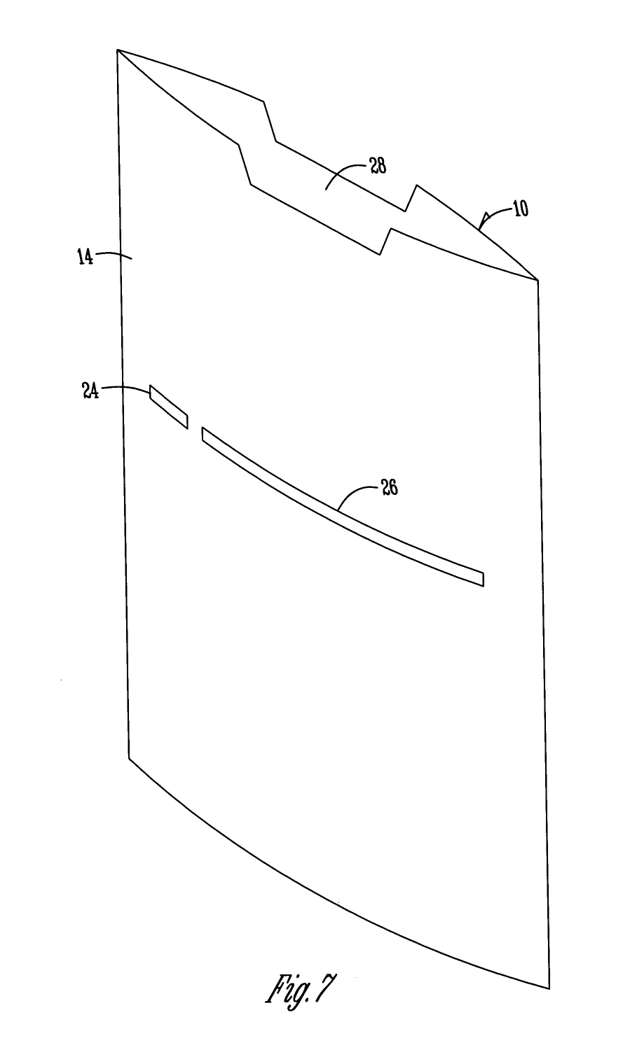

FIG. 7 illustrates a perspective view of one embodiment of a sleeve 12 of the present invention. The sleeve 12 has a front side 14 and a rear side 28. Shown on the front side 14 are apertures 24 and 26. The sleeve 12 is adapted to receive an insert.

In operation, the retirement savings calculator helps a user to determine the percentage of annual salary that should be deferred to help ensure that the user is on track towards a secure retirement. The user may be a participant in a group retirement plan. A group retirement plan provider may provide the retirement savings calculator to participants in the plan either directly, through group retirement plan sponsors, consultants, or otherwise. In a first step of using the retirement savings calculator, the user determines their savings ratio. The savings ratio is the ratio of current savings to current salary. A user finds the amount they currently have saved for retirement which preferably includes individual retirement accounts (IRAs) and retirement savings plans. The user can find this amount by sliding the insert up and down until the amount of savings is revealed in the appropriate window. Next, the user can find their salary amount, rounding up if necessary as printed on the sleeve. There is a corresponding savings ratio displayed in the window based on the user's salary and savings. Preferably, there is an input area on the retirement savings calculator so that the user can write their savings ratio there for easy reference.

Next, the user is instructed regarding replacement income percentage. The user needs to find the amount of their pre-retirement salary that they need to replace when they retire. The user needs to consider how much of their salary (projected to a retirement age preferably set at age 65) to replace. Studies suggest that a retiree may need between 80 to 100 percent of their pre-retirement income to maintain their current lifestyle at retirement. A user may need less than 100 percent of their pre-retirement income if they will not be paying a mortgage or will not be supporting dependents. The user may need 100 percent or more of their pre-retirement income if they plan to purchase a second home or pay rent or if the user or dependent will need additional medical care. These or other criteria that an individual may want to consider are preferably printed on the sleeve. An input area is presented on the sleeve so that a user can write or otherwise record their replacement income percentage. Preferably the replacement income percentage excludes social security.

Next, the user calculates a deferral percentage. The user finds their savings ratio previously calculated, rounding up if necessary. The savings ratio should be revealed within a window, and may require the user to adjust the insert within the sleeve.

Next the user finds their current age, rounding up if necessary. The user also selects the salary deferral percentage based on the replacement income percentage previously determined. A deferral percentage corresponding to the provided savings ratio, salary deferral percentage, and approximate age is revealed. There is an input area for the user to record their salary deferral percentage. The salary deferral percentage is the total of the user's contribution and any matching employer contribution, if any, to the user.

The retirement savings calculator also presents information to assist the user in taking action if their current salary deferral percentage is lower than the percentage calculated. For example, a table showing the impact of a bi-weekly paycheck if salary deferral is increased can be provided. Thus, the user can see the effect of increasing salary deferral percentage on their net take home pay. In addition, contact information can also be provided on the retirement savings calculator.

The present invention contemplates numerous variations in the particular structure of the calculator, the type of materials used, including differences in the number or placement of apertures, the movement of the insert, the shape of the insert or sleeve, whether the sleeve is open ended or close ended, the materials used to construct the retirement savings calculator, the particular levels of income used, the particular savings ratios used, variations in the underlying assumptions used, and other variations within the spirit and scope of the invention.

The present invention also contemplates that various funding mechanisms may be used for the desired replacement income. For example, an income annuity-type mechanism with a 3 percent annual cost-of-living increase and a lifetime payment with a minimum 10 year certain payment may be used. An alternative funding mechanism would be to use periodic withdrawal from mutual funds (such as a mix of equities and bonds). Of course, the present invention contemplates numerous other variations in the funding mechanisms. It is to be understood that although the funding mechanism used and/or other assumptions may be communicated to individuals, the individuals need not have any understanding of the complex calculations involved in order to operate the retirement savings calculator.

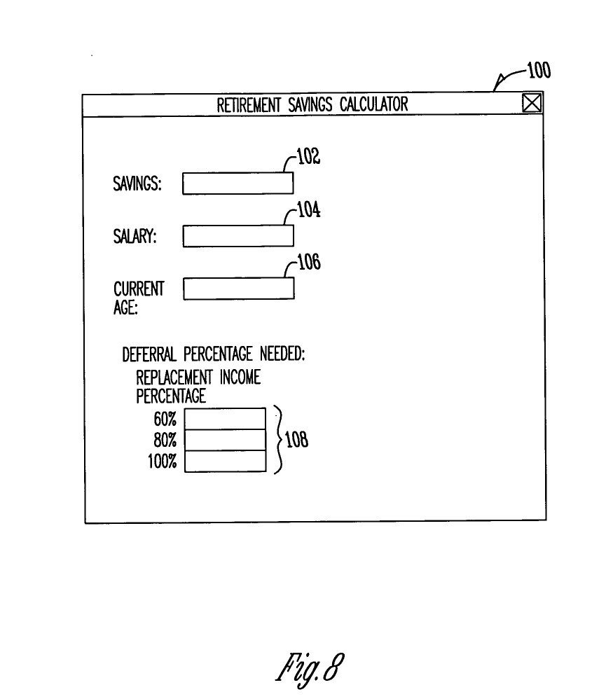

Other embodiments of the present invention include a computer implemented embodiment. FIG. 8 illustrates one embodiment of a screen display of one embodiment of a retirement savings calculator of the present invention. In FIG. 8, a screen display 100 includes a plurality of inputs. Preferably, these inputs include a savings value 102, a salary value 104, and a current age 106. A deferral percentage 108 is calculated for one or more replacement income percentages. The present invention contemplates variations in the number of inputs used. For example, replacement income percentage can be an additional input. Preferably, however, few inputs are used in order to simplify the process of computing a deferral percentage.

Preferably, the screen display is provided over the web. Source code for the software embodiments can be written in any number of computer languages, with any number of tools, as are well-known in the art.

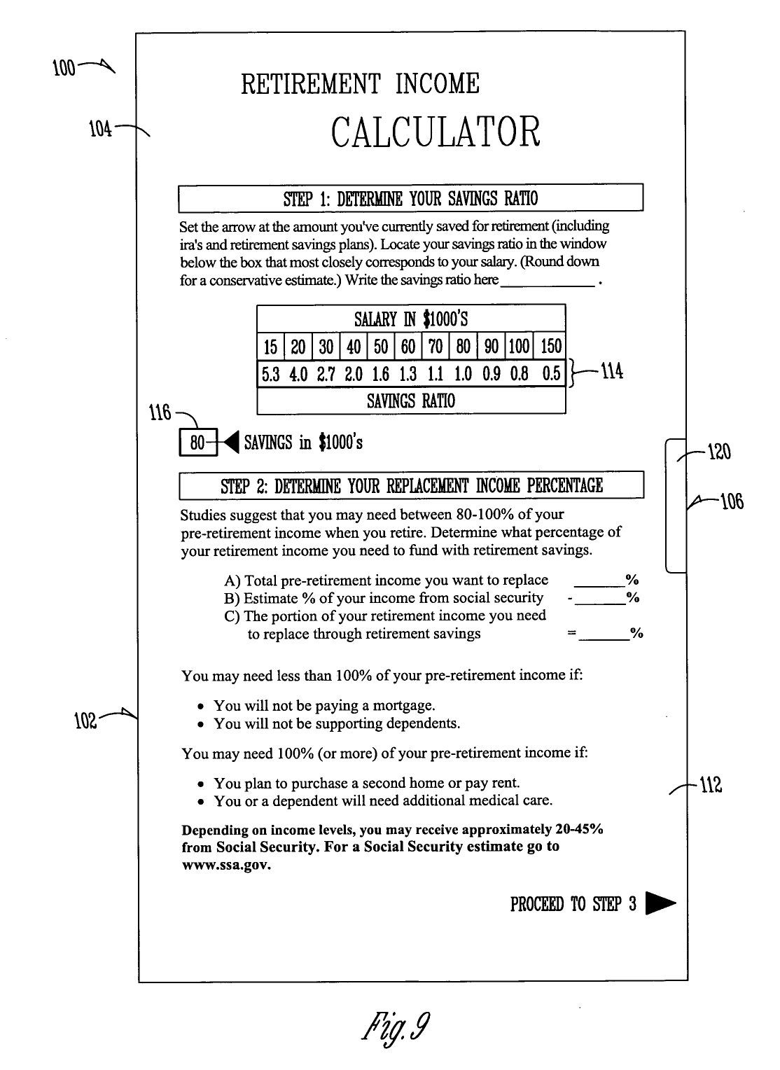

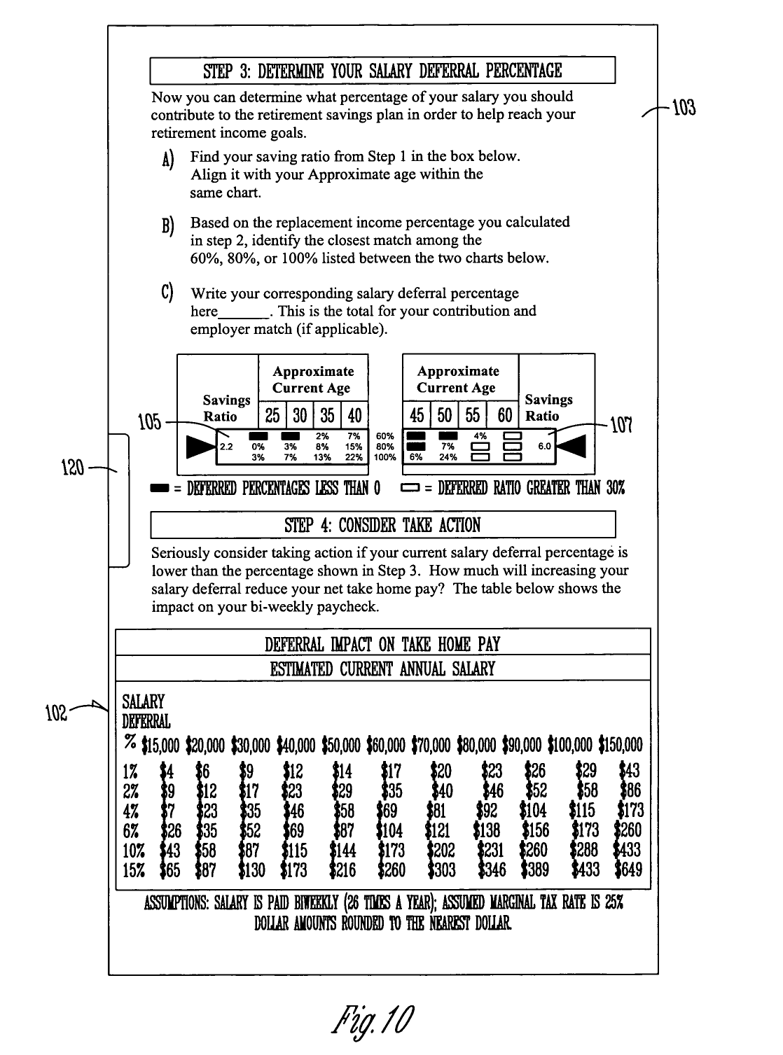

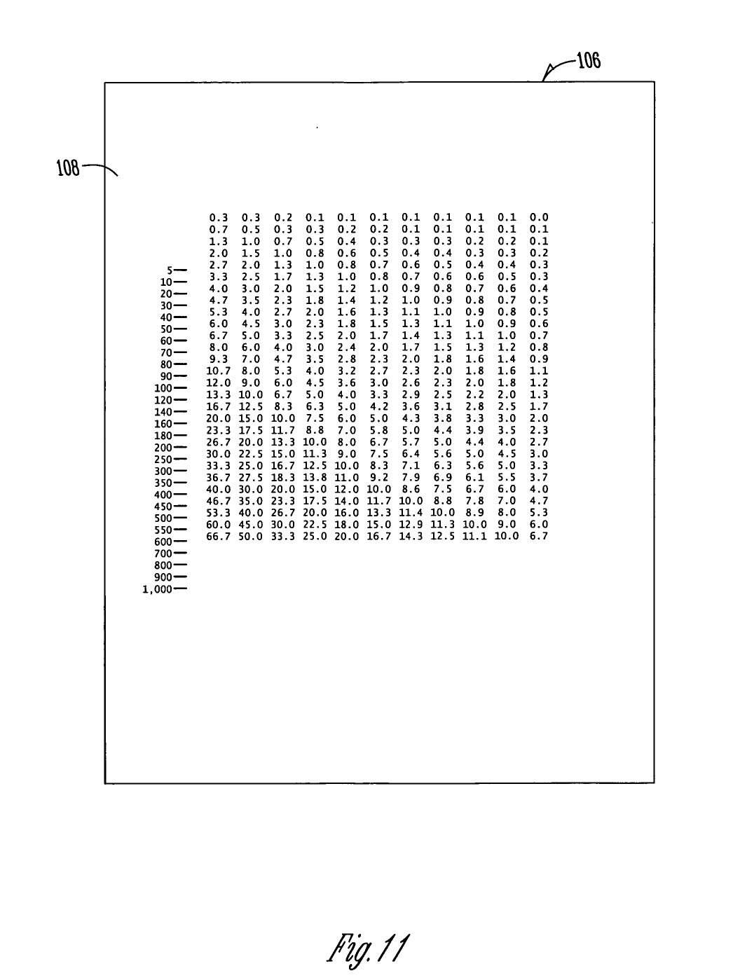

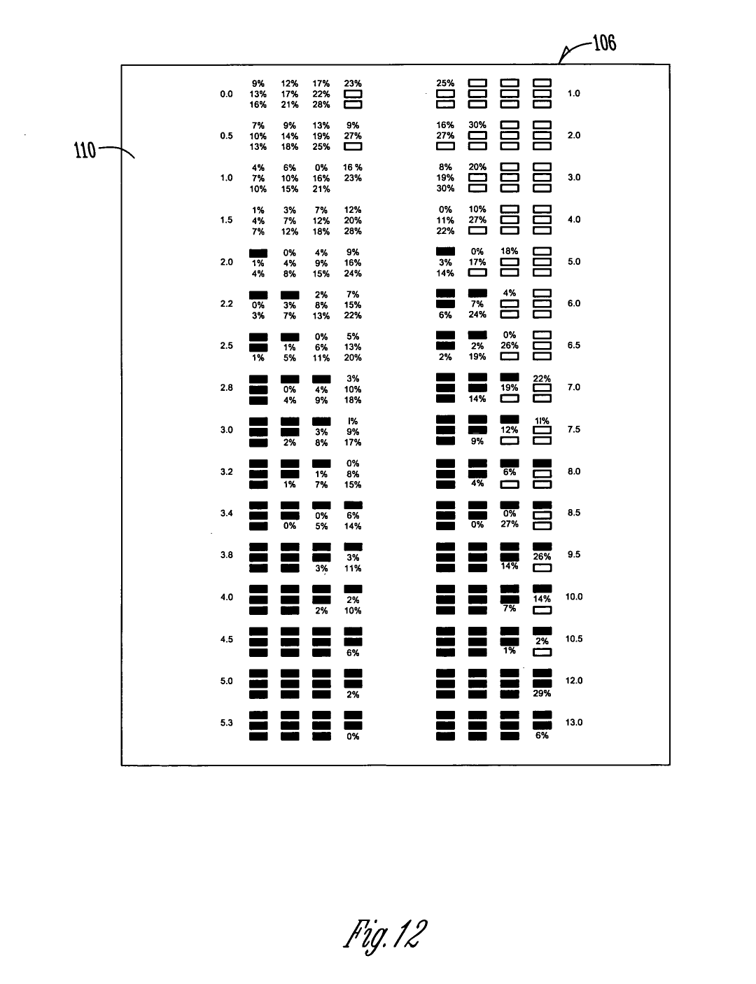

FIGS. 9-12 illustrate another embodiment of the present invention configured to provide increased privacy. The retirement savings calculator 100 includes a sleeve 102 and an insert 106. An aperture 120 in the sleeve 102 allows the insert 106 to be moved up and down. The insert 106 has a length which is substantially shorter than a length of the sleeve 102, thereby adding increased privacy as one need not adjust the insert 106 beyond the top or bottom of the sleeve 102 in use. The sleeve 102 has a first side 104 with a savings ratio aperture 114 and a savings aperture 116. The sleeve 102 has a second side 103 with apertures 105, 107 for showing salary deferral percentage. The insert 106 has a corresponding first side 108 (see FIG. 11) and second side 110 (see FIG. 12).

Thus, a retirement savings calculator has been disclosed which can be implemented in software or in physical form. Although specific embodiments have been disclosed herein, the present invention is not to be limited to what is disclosed herein, but rather includes numerous variations within the spirit and scope of the invention.

What is claimed is:

1. A retirement savings calculator for computing a deferral percentage needed to replace income at retirement age, comprising:
a sleeve having an open end, and a plurality of windows;
an insert slidably insertable into the open end of the sleeve;
wherein the insert has a plurality of savings values and a plurality of savings ratios printed upon the insert;
wherein the plurality of savings values and the plurality of savings ratios are arranged upon the insert such that when the insert is positioned in the open end of the sleeve, one of the savings values of the insert and a corresponding savings ratio of the insert is exposed through at least one of the plurality of windows, the corresponding savings ratio also corresponding with a salary value printed on the sleeve.

2. The retirement savings calculator of claim 1 wherein the insert has a second plurality of savings ratios and a plurality of deferral percentages, wherein the second plurality of savings ratios and the plurality of deferral percentages being printed upon the insert and wherein the second plurality of savings ratios and the plurality of deferral percentages are arranged upon the insert such that when the insert is positioned in the open end of the sleeve, one of the second plurality of savings ratios and at least one corresponding deferral percentage of the insert are exposed through at least one of the plurality of windows.

3. The retirement savings calculator of claim 1 wherein the plurality of savings values and the plurality of savings ratios are printed on a first side of the insert.

4. The retirement savings calculator of claim 2 wherein the plurality of savings values and the plurality of savings ratios are printed on a first side of the insert.

5. The retirement savings calculator of claim 4 wherein the second plurality of savings ratios and the plurality of deferral percentages are printed on a second side of the insert.

6. The retirement savings calculator of claim 1 further comprising an input area instructing a user to record a calculated savings ratio.

7. The retirement savings calculator of claim 2 further comprising a plurality of replacement income percentages printed on the sleeve to correspond with subsets of the plurality of deferral percentages.

8. The retirement calculator of claim 2 further comprising a plurality of approximate current ages printed on the sleeve.

9. The retirement calculator of claim 1 further comprising a printed table illustrating effect of increasing salary deferral percentage on net take home pay.

10. The retirement calculator of claim 1 further comprising an input area instructing a user to record a replacement income percentage.

11. The retirement calculator of claim 2 further comprising an input area instructing a user to record a salary deferral percentage.

12. A retirement savings calculator, comprising:
means for revealing a savings ratio based on a savings value and a salary value;
means for revealing a deferral percentage needed to replace income at retirement based on the savings ratio, an approximate age, and a replacement income percentage.

13. A retirement savings calculator for computing a deferral percentage needed to replace income at retirement age, comprising:
a sleeve;
an insert slidably positionable within the sleeve;
a savings ratio window for revealing a savings ratio based on salary and savings;
a deferral percentage window for revealing the deferral percentage needed to replace income at retirement age.

14. A method of promoting contributions to a retirement plan, comprising:
providing a retirement savings calculator to group retirement plan participants, the retirement savings calculator adapted for computing a deferral percentage needed to replace income at retirement age.

15. The method of claim 14 wherein the retirement savings calculator computes a savings ratio value and a deferral percentage needed to replace income at retirement value based on the savings ratio value.

16. The method of claim 15 wherein the retirement savings calculator comprises a sleeve and an insert.

17. The method of claim 14 further comprising receiving an instruction to change a deferral percentage associated with an account of one of the participants to match the deferral percentage needed to replace income at retirement age.

18. The method of claim 14 further comprising receiving contributions into the group retirement plan from the participants.

19. The method of claim 14 wherein the retirement savings computes a savings ratio value in a first step and a deferral percentage value in a subsequent step.

20. A retirement savings calculator, comprising:
a savings input for a savings value;
a salary input for a salary value;
a deferral percentage output for a deferral percentage needed to reach a retirement savings goal.

21. The retirement savings calculator of claim 20 wherein the retirement savings calculator includes a first body and a second body movably connected to each other to provide for inputting the inputs and outputting the output.

22. The retirement savings calculator of claim 20 wherein the retirement savings calculator is software implemented.

23. The retirement savings calculator of claim 20 further comprising a current age input for a current age.

24. The retirement savings calculator of claim 20 wherein a salary ratio value is computed as an intermediate step between the savings input and the salary input and the deferral percentage output.

25. The retirement savings calculator of claim 20 further comprising means for computing the deferral percentage from the savings value and the salary value.
